(19) United States
(12) Patent Application Publication
(10) Pub. No.: US 2017/0127106 A1
(43) Pub. Date: May 4, 2017

(54) METHOD AND APPARATUS FOR VIDEO CONTENT RECOMMENDATION FOR NIGHT-TIME VIEWING

(71) Applicant: THOMSON LICENSING, Issy de Moulineaux (FR)

(72) Inventors: Swayambhoo JAIN, Minneapolis, MN (US); Azin ASHKAN, San Jose, CA (US); Marc JOYE, Palo Alto, CA (US); Alvita TRAN, San Jose, CA (US); Akshay PUSHPARAJA, Sunnyvale, CA (US); Jaideep CHANDRASHEKAR, San Francisco, CA (US); Shi ZHI, Urbana, IL (US); Junyang QIAN, Stanford, CA (US)

(21) Appl. No.: 14/925,168

(22) Filed: Oct. 28, 2015

(51) Int. Cl. H04N 21/2668; H04N 21/233; H04N 21/234; H04N 21/25

(52) U.S. Cl. CPC H04N 21/2668; H04N 21/251; H04N 21/233; H04N 21/23418

(57) ABSTRACT

A method for recommending content from among a collection of available content includes determining for each of available content at least one of a first, second and third content ratings related to (1) content characteristics that interfere with sleep patterns; (2) excitement level of the content; and (3) dynamic range of content audio, respectively. Thereafter, the content having a content rating that least interfere with sleep patterns is established. The available content having the content rating that least interferes with sleep patterns is recommended.

### TECHNICAL FIELD

This invention relates to a technique for recommending content for viewing at night.

### BACKGROUND ART

Today, users can acquire content from a variety of sources, including on-line content providers such as Technicolor's M-GO content delivery service. In connection with providing users with content, many on-line content providers also provide personalized content recommendations usually by taking into account the user's past viewing history. Often, content providers make recommendations based on what content will engage a user the most. For present purposes, the phrase “engage a user” relates to the level of interest of a user in a particular piece of content. The phrase “excite a user,” as used hereinafter, relates to a degree to which a particular piece of content stimulates or arouses the user (thus increasing the user's physiological response measurable by an increase in blood pressure or galvanic skin response). In some instances, the content that will most engage will most excite the user. However, viewing exciting content prior to bed time can disturb a viewer's sleep cycle because exciting videos often have bright, vivid in colors and/or dynamic audio which can adversely affect the viewer's senses, and thus affect sleep. Moreover, exciting content even without vivid colors and/or dynamic audio can leave the viewer agitated after viewing which can also adversely affect sleep patterns. For this reason, many users avoid watching exciting video content at night.

There currently exist software programs that filter content to alter visual attributes of the content, such as color, screen brightness and contrast, among others. Reducing the visual impact of the content makes the content more suitable for night-time viewing. For example, research has shown that content rich in the blue part of the visual spectrum tends to keep the human brain active, thus adversely affecting sleep patterns. However, altering the display attributes affects the quality of the video content perceived by the user. Moreover, altering the visual attributes of the content will not necessarily make the content less dramatic in terms of stimulating the user so as to adversely affect sleep patterns,

Thus, a need exists for a content recommendation technique that takes into account the ease of night time viewing and impact on the user's sleep.

### BRIEF SUMMARY OF THE INVENTION

Briefly, in accordance with an illustrative embodiment of the present principles, a method for recommending content from among a collection of available content commences by determining for each of available content at least one of a first, second and third content ratings related to (1) content characteristics that interfere with sleep patterns; (2) excitement level of the content; and (3) dynamic range of content audio, respectively. Thereafter, which of the available content having a highest content rating value for the at least one of the at least one of a first, second and third content ratings that least interfere with sleep patterns is established. The available content having the highest content rating is recommended.

### BRIEF SUMMARY OF THE DRAWINGS

FIG. 1 depicts a block schematic diagram of a content delivery system for generating content recommendations in accordance with the present principles;

FIG. 2 depicts an exemplary content receiving device comprising part of the system of FIG. 1 and

FIG. 3 depicts in flow chart form the steps of a process for generating content recommendations in accordance with the present principles.

### DETAILED DESCRIPTION

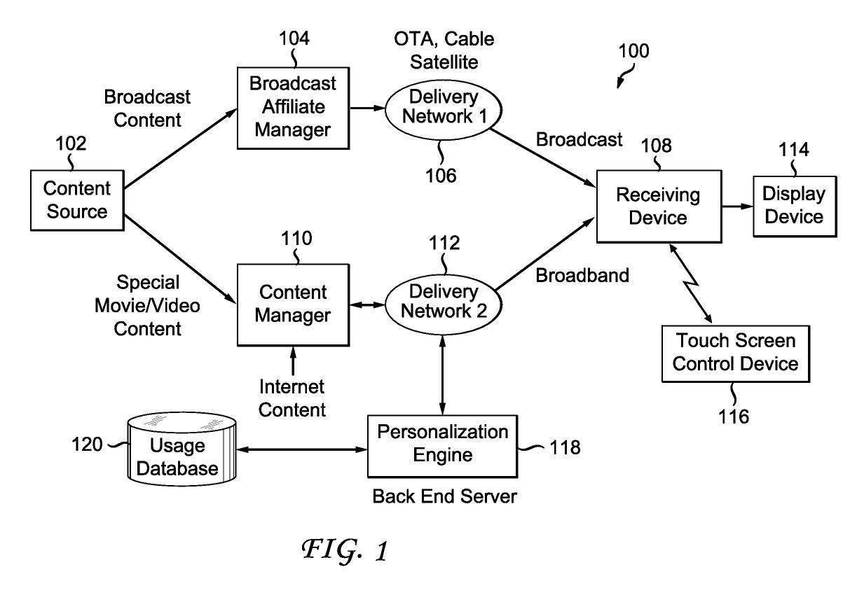

FIG. 1 depicts a block diagram of an embodiment of a system 100 for delivering content to a home or end user for practicing the content recommendation method of the present principles. The system 100 includes a content source 102, such as a movie studio or production house or agent thereof for providing movies, television programs and/or other audio-visual content. The content source 102 can supply content in at least one of two forms. For example, the content source 102 can supply content to a broadcast affiliate manager 104, typically, a broadcast television network, such as the American Broadcasting Company (ABC), National Broadcasting Company (NBC), Columbia Broadcasting System (CBS), etc. The broadcast affiliate manager 104 may collect and store the content, and can schedule delivery of the content over a delivery network, shown as the delivery network 106. Delivery network 106 can include a satellite link transmission from a national center to one or more regional or local centers. The delivery network 106 can also include local content delivery using local delivery systems such as over-the-air broadcast, satellite broadcast, or cable television broadcast.

A content receiving device 108, typically situated in a user's home, enjoys a connection to the delivery network 106 to enable a user to search and select content. The content receiving device 108 can take many forms and could exist as a set top box/digital video recorder (DVR), a gateway, a modem, etc. Further, the content receiving device 108 could act as entry point, or gateway, for a home network system (not shown) that includes additional devices configured as either client or peer devices in such a network.

The content source 102 can also supply a second form of content, hereinafter referred to as special content. Special content can include content delivered for premium viewing, pay-per-view content or content otherwise not provided to the broadcast affiliate manager 104. For example, such special content can include movies, video games or other audio/visual content. In many cases, the special content can comprise content specifically requested by the user, in contrast to content which the broadcast affiliate manager 104 selects and schedules for delivery.

In practice, the content source 102 supplies special content to a content manager 110, which can comprise service provider, such as an Internet website, affiliated with a content provider, broadcast service, or delivery network service. Thus, the content manager 110 can incorporate Internet content for delivery to users. In this regard, the content manager 110 typically delivers content to the user's content receiving device 108 over a separate delivery network 112, which can include one or more high-speed broadband communications networks, including the Internet. Note that the content delivery network 112 could also serve to deliver content from the broadcast affiliate manager 104, and by the same token, the delivery network 106 could deliver appropriately formatted content from the content manager 110, although FIG. 1 does not specifically depict such cross links between the networks 106 and 112. In addition, the user may also obtain content through the content receiving device 108 directly from the Internet via delivery network 112 without necessarily having the content managed by the content manager 110.

Delivery of the special content can occur separately from the broadcast content. Thus, the special content can exist as an alternative media for selection by the user. For instance, the special content could comprise a library of movies not yet available as broadcast content. Alternatively, the special content can augment the broadcast content, thus providing alternative information, purchase and merchandising options, enhancement material, etc. In another embodiment, the special content could completely replace all or part of the broadcast content

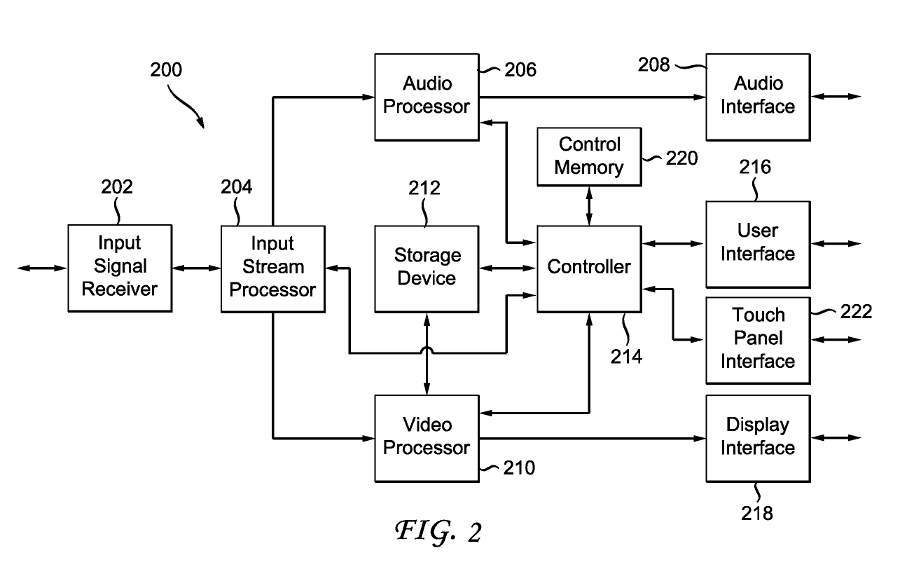

As discussed, the content receiving device 108 can receive content from one or both of delivery networks 106 and delivery network 112. The content receiving device 108 processes the received content based on user preferences and commands. The content receiving device 108 may also include a storage device, such as a hard drive or optical disk drive, for recording and playing back content. Further details of the operation of the content receiving device 108 and features associated with playback of stored content will become apparent in accordance the description of the content receiving device provided hereinafter in relation to FIG. 2. The content receiving device 108 provides the content processed thereby to a display device 114, which can comprise a conventional 2-D type display or an advanced 3-D display.

The content receiving device 108 can interface with a second screen, such as a touch screen control device 116, which could include a laptop computer, tablet, smart phone or other device with wireless communications and information processing capabilities. Depending on its capabilities, the touch screen device 116 can display content, either the same as, or different from, the content displayed on the display device 114. For example, the touch screen control device 116 could execute a second screen application that would enable the user to control the content receiving device 108 and/or the display device 114. Another second screen application executed by the touch screen display device 116 could enable the user to interact with the content. The touch screen control device 116 can interface with receiving device 108 using any well-known wireless transmission protocols, such as infra-red (IR) or radio frequency (RF) communications and could employ such standard protocols such as the infra-red data association (IRDA) standard, Wi-Fi, Bluetooth and the like, or any proprietary protocol.

Still referring to FIG. 1, the system 100 also includes a back end server 118 and a usage database 120. The back end server 118 includes a personalization engine that analyzes content usage information from a user and makes content recommendations based on such information in accordance with the present principles as described in greater detail below. The usage database 120 stores the content usage information. In some cases, the usage database 120 could comprise part of the back end server 118. In the illustrated embodiment, the back end server 118 enjoys a connection to the delivery network 112.

FIG. 2 depicts a block diagram of an exemplary embodiment of the content receiving device 108 of FIG. 1. The content receiving device of FIG. 2 can comprise part of a gateway device, modem, set-top box, or other similar communications device (not shown). The content receiving device 108 could also comprise part of another system including an audio device or a display device. In either case, the block diagram of FIG. 2 has omitted some elements, such as a power supply, that support the operation of the content receiving device 108 in the interest of conciseness, as such elements well known to those skilled in the art.

The content receiving device 108 of FIG. 2 includes an input signal receiver 202 that receives content from either of the networks 106 and 112 of FIG. 1. The input signal receiver 202 can take the form of one of several known receiver circuits for receiving, demodulating and decoding signals having various network protocols. Typically, a user controls the input signal receiver 202 via a remote control (not shown) or other device such as the touch screen control device 116 or FIG. 1, which interfaces with the content receiving device 108 via a touch panel interface 222.

The input signal receiver 202 supplies a demodulated and decoded signal to an input stream processor 204, which performs the final input signal selection and processing, including separation of video from audio. The input stream processor 204 supplies the audio to an audio processor 206 for conversion from the received format (e.g., a compressed digital signal), to an analog signal. The audio processor 206 transmits the analog audio to an audio interface 208 for subsequent transmission to the display device 114 of FIG. 1 and/or a separate audio reproduction system or other device (not shown). Alternatively, the audio processor 206 could supply digital audio to the audio interface 208 for output to the display device 114 or other system or device using a High-Definition Multimedia Interface (HDMI) cable or alternate audio interface such as via a Sony/Philips Digital Interconnect Format (SPDIF). The audio interface 208 may also include amplifiers for driving one more sets of speakers (not shown). The audio processor 206 will performs any necessary conversion for the storage of the audio.

The input stream processor supplies the video to a video processor 210. The video can have one of several well-known several formats and the video processor 210 undertakes the necessary conversion of the video for storage and for output to a display interface 218 that connects to the display device 114 of FIG. 1. The display interface 218 can comprise an analog signal interface such as red-green-blue (RGB) or a digital interface such as HDMI.

The content receiving device 108 of FIG. 2 includes a storage device 212 for storing audio and video from the audio processor 206 and the video processor 210, respectively. The storage device 212 records and plays back under the control of a controller 214, based on user entered commands, e.g., record, play, fast-forward (FF) and rewind (REW), received from the user via the user interface 216 and/or the touch panel interface 222. The storage device 212 can comprise a hard disk drive, one or more large capacity integrated electronic memories, such as static RAM (SRAM), or dynamic RAM (DRAM), or an interchangeable optical disk storage system such as a compact disk (CD) drive or digital video disk (DVD) drive. The storage device supplies recorded audio and to the audio interface 204 and the display interface 218, respectively, for consumption by the user.

The controller 214 enjoys connections to the various other elements in the content receiving device 108, including the input stream processor 202, the audio processor 206, the video processor 210, the storage device 212, and the user interface 216. The controller 214 manages the conversion process for converting the input stream signal into audio and video signal for storage on the storage device 212 or for display on the display device 114 of FIG. 1. The controller 214 also manages the retrieval and playback of stored content.

The controller 214 has a connection to a control memory 220 (e.g., volatile or non-volatile memory, including RAM, SRAM, DRAM, ROM, programmable ROM (PROM), flash memory, electronically programmable ROM (EPROM), electronically erasable programmable ROM (EEPROM), etc.) for storing information and instruction code for controller 214. The Control memory 220 can also store a set of elements, such as graphic elements, containing content. Alternatively, the control memory 220 can store the graphic elements in identified or grouped memory locations and use an access or location table to identify the memory locations for the various portions of information related to the graphic elements. Further, the implementation of the control memory 220 can include several possible embodiments, such as a single memory device or, alternatively, more than one memory circuit communicatively connected or coupled together to form a shared or common memory. Still further, the memory may be included with other circuitry, such as portions of bus communications circuitry, in a larger circuit.

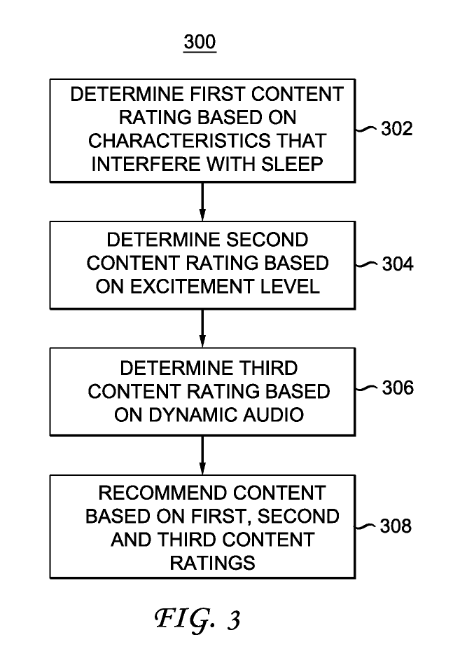

FIG. 3 depicts the steps of a method 300 for recommending content suitable for night-time viewing. The content recommendation method 300 of the present principles takes account of at least one or more of the following factors that influence content suitability for night-time viewing:

1. Visual characteristics that interfere with sleep patterns, such as color, brightness, and contrast for example;

2. The excitement level of the content (e.g., the content includes dramatic visual scenes, for example, car chases, fighting, gun fire, and the like); and

3. The dynamic range of the audio (e.g., loudness, pitch and frequency, for example.)

To enable the content method 300 of the present principles to take into account the above-listed factors, the content provided by the content source 102 typically will have a first, second, and third content rating associated therewith. The first content rating reflects the degree to which characteristics of the content, and especially visual attributes of the content, such as color, brightness, and contrast, interfere with human sleep. Content that has characteristics, and especially visual attributes that interfere with sleep, such as a color palette having in the blue spectrum will have a relatively low content rating. Thus, for example, assume a first content rating on a scale of 1-10, with content having a first content rating of “1” most interfering with human sleep, and “10” for content that least interferes with sleep. Thus, content having a color palette heavy in the blue spectrum typically would have a first content rating of, for example say 1-2, whereas content with little if any blue might have a first content rating of 7-8. Establishing a first content rating for other visual attributes that influence sleep, such as brightness and contrast could occur by determining what percentage of the content had contrast and/or brightness or other such visual factors above a threshold level, for example 75-80% of a total available level. Other techniques could serve to establish a first content rating for the content.

Typically, the content will also have a second rating based on its excitement level. Determining the excitement level could occur by determining what percentage of the content has scenes that depict action (e.g., car chases, gun fights, physical altercations, and the like). Thus, content having a high level of excitement would have a low second content rating. Conversely, content having a low level of excitement would have a high second content rating. Like the first content rating, in one embodiment of the present principles the second content rating could also employ a 1-10 scale.

In addition, the content typically will have a third content rating based on the dynamic audio in the content. The dynamic audio in the content can be measured in several different ways. For example, one measure of dynamic audio would be the frequency (how often) the audio changes from a first threshold, for example 50-60 dB to levels in excess of a second threshold, for example 85-90 dB. Another measure would be the percentage of the content that has audio in excess of a set threshold (e.g., 85-90 dB). Other audio attributes of the content such as pitch and frequency would also affect the second content rating.

Typically, the content producer will assign first, second and third content ratings to the content. The personalization engine 118 of FIG. 1 can then assess the first, second and third content ratings of content in the content source 102 to recommend content, which has the highest of all three ratings. Basing the recommendation on the content with the highest of all three ratings reduces the likelihood of recommending content which may have one or even two high content ratings, but a very low rating for the other category and thus still interfere with the user's sleep.

In some instances, the content producer might supply content with only two or only one content ratings. Thus, the personalization engine 118 will have to make a recommendation on that content rating alone. Alternatively, the personalization engine 118 could screen the content having such missing content ratings (or even no content ratings at all) to assign the content ratings itself and then make the content recommendation based on such assigned content ratings. In alternate embodiments of the present principles the receiving device can include a personalization engine of the present principles, such as the personalization engine 118 of FIG. 1, for making content recommendations and even assigning content ratings as described above.

The foregoing describes a technique for recommending content for viewing at night.

1. A method for recommending content from among a collection of available content, comprising:
determining for each of available content at least one of a first, second and third content ratings related to (1) content characteristics that interfere with sleep patterns; (2) excitement level of the content; and (3) dynamic range of content audio, respectively;
establishing which of the available content has a content rating value for the at least one of the at least one of a first, second and third content ratings that least interfere with sleep patterns; and
recommending content within the available content having the content rating value that least interferes with sleep patterns.

2. The method according to claim 1 wherein the first content rating is related to visual content characteristics.

3. The method according to claim 2 wherein the visual content characteristics include at least one of color, brightness and contrast.

4. The method according to claim 1 wherein the dynamic audio associated with the third content rating includes at least one of loudness, pitch and frequency.

5. A method for recommending content from among a collection of available content, comprising:
determining for each of available content a first, second and third content ratings related to (1) content characteristics that interfere with sleep patterns; (2) excitement level of the content; and (3) dynamic range of content audio, respectively;
establishing which of the available content has highest first, second and third content ratings so as to least interfere with sleep patterns; and
recommending content within the available content having highest first, second and third content ratings.

6. A system for recommending content from among a collection of available content, comprising:
a database for storing available content; and
a processor configured to: (1) determine for each of available content at least one of a first, second and third content ratings related to (a) content characteristics that interfere with sleep patterns; (b) excitement level of the content; and (c) dynamic range of content audio, respectively; (2) establish which of the available content has a content rating value for the at least one of the at least one of a first, second and third content ratings that least interfere with sleep patterns; and (3) recommend content within the available content having the content rating value that least interferes with sleep patterns.

7. The system according to claim 6 wherein the first content rating is related to visual content characteristics.

8. The system according to claim 7 wherein the visual content characteristics include at least one of color, brightness and contrast.

9. The system according to claim 6 wherein the dynamic audio associated with the third content rating includes at least one of loudness, pitch and frequency.

10. A method for recommending content from among a collection of available content, comprising:
determining, for each piece of available content, a rating based on (1) content characteristics that interfere with sleep patterns; (2) excitement level of the content; and (3) dynamic range of content audio, respectively; and
recommending for night viewing content within the available content that least interferes with sleep patterns based on the content rating.

11. The method according to claim 10 wherein the content rating depends on visual content characteristics.

12. The method according to claim 11 wherein the visual content characteristics include at least one of color, brightness and contrast.

13. The method according to claim 10 wherein the dynamic audio includes at least one of loudness, pitch and frequency.
